(19) United States
(12) Patent Application Publication
(10) Pub. No.: US 2023/0107782 A1
(43) Pub. Date: Apr. 6, 2023

(54) INJECTOR FOR INTRODUCING A FLUID WITH IMPROVED FLOW ROBUSTNESS

(71) Applicant: Robert Bosch GmbH, Stuttgart (DE)

(72) Inventors: Matthias Lausch, Leonberg (DE); Tobias Knorsch, Grossrinderfeld (DE)

(21) Appl. No.: 17/911,197

(22) PCT Filed: Mar. 9, 2021
(86) PCT No.: PCT/EP2021/055883

§ 371 Date: Sep. 13, 2022

(30) Foreign Application Priority Data
Apr. 27, 2020 (DE) 10 2020 205 281.6

(51) Int. Cl. F02M 61/18

(52) U.S. Cl. CPC F02M 61/1826; F02M 61/1846; F02M 61/1886

(57) ABSTRACT

An injector for introducing a fluid. The injector has a valve seat in which a multiplicity of injection holes are formed, and a closing element that releases and closes a fluid path to the injection holes, a size of an inlet area of at least two injection holes being different, and a spacing of the injection holes in the circumferential direction to the adjacent injection hole in each case being selected as a function of the size of the inlet areas of the injection holes.

### FIELD

The present invention relates to an injector for introducing a fluid, for example a fuel injector of an internal combustion engine, having improved flow robustness compared to fine geometrical flows of flow-conducting surfaces in valve seats.

### BACKGROUND INFORMATION

In the related art, injectors are available in various embodiments, for example as fuel injectors. In order to introduce a fluid, a closing element, for example a valve needle, is moved by an actuator against a closing spring or the like, in such a way that a desired quantity of fuel is injected via injection holes that are provided in a valve seat. In direct-injecting injectors, taking into account the geometrical properties of a respective cylinder, the injection holes are, as far as possible, configured in such a way that the resulting spray clouds are adapted as precisely as possible to the geometric properties. In direct-injecting injectors, the closing elements open inwardly, a plurality of injection holes being released simultaneously. The fuel then flows to the injection holes through an annular gap between the end of the closing element and an injector wall, e.g. also via flow pockets on the injector wall or on the closing element, and is injected into a combustion chamber. The largest flow deflection in the injection process takes place at an inlet area of the injection hole, situated on an inner side of the valve seat. A flow structure is here a function in particular of the flow into the inlets of the injection holes. As a consequence, this influences the mass flow that can be injected into the combustion chamber through an injection hole, and in particular also influences the flow properties of the spray that forms in the combustion chamber. It would be desirable here to have a metering of quantities of fuel to the respective injection holes that is as precise as possible.

### SUMMARY

An injector according to the present invention for introducing a fluid, has an advantage that a significantly improved precise metering of quantities of fluid to individual injection holes of the injector is possible. As a result, on the one hand in particular a robustness of the fluid flow inside the injector when the injector is open is achieved, and on the other hand when the fluid exits from the injection hole a spray that is formed in a defined manner is also achieved. According to the present invention, this is enabled in that the injector has a valve seat and a multiplicity of injection holes provided in the valve seat. In addition, a closing element, in particular a valve needle, preferably having a ball at one end, is provided that releases and closes a fluid path to the injection hole. The closing element preferably seals on a sealing seat inside the valve seat. Here, an inlet area of at least two injection holes differs from one another. In addition, a spacing of the injection holes in the circumferential direction of the injector from the adjacent injection hole in each case is selected as a function of the size of the inlet areas of the injection holes. In this way, it is ensured that an inflow, which flows through an annular gap in the region of the sealing seat on the valve seat, is apportioned internally to the various injection holes in a manner corresponding to the size of their inlet areas. In particular, in this way the selected spacings in the circumferential direction can be prevented from causing pronounced local oversupplying and competition in the mass distribution of the fluid. In this way, it is possible for potential fluctuations in the mass flow to be avoided, as far as possible, at different injectors, which are mass-produced components. The present invention in particular increases a robustness of a flow to the injection holes inside the injector, at the injection hole inlet.

Preferred developments of the present invention are disclosed herein.

Further preferably, according to an example embodiment of the present invention, a pie-shaped circular segment is assigned to each injection hole, an injection hole center axis being situated in a range of ±5° around a center line of each assigned circular segment. The circular segment goes out from a center axis of the injector. The sizes of the circular segments are selected corresponding to the sizes of the inlet areas of the injection holes. That is, a ratio of the sizes between the inlet areas of the injection holes is substantially equal to a ratio of the size of the circular segments in which the injection holes are situated. In this way, a spacing rule is defined between injection holes that are adjacent in the circumferential direction, as a function of the size of the inlet area of the injection holes, with a deviation of the circular segments in a range of ±5°, which can further increase the robustness of the quantities of fluid flowing to the individual injection holes.

Particularly preferably, according to an example embodiment of the present invention, each injection hole is situated precisely on a center line of the circular segment. This further increases the flow robustness and accuracy of the fluid quantities that are to flow through the respective injection holes.

According to a further preferred embodiment of the present invention, the largest injection hole and the smallest injection hole each have an inlet area that is a maximum of 45% from an average value for all the inlet areas. Particularly preferably, the largest and smallest injection holes differ, in their inlet areas, by a maximum of 40% from the average value of all inlet areas, in particular 35%, more particularly 30%, and more particularly 25%.

Further preferably, according to an example embodiment of the present invention, each injection hole has an injection hole center axis that has a radial distance from a center axis of the injector, the individual radial distances of the injection hole center axes differing from an average value of all radial distances of the injection hole center axes to the center axis of the injector by a maximum of 30%. Particularly preferably, the radial distances differ by a maximum of 25%, and more preferably by a maximum of 20%.

Further preferably, according to an example embodiment of the present invention, all injection hole center axes are situated at the same radius. In this way, geometrical properties that are as simple as possible can be produced at the valve seat.

Particularly preferably, according to an example embodiment of the present invention, the number of the injection holes is in a range of from five to seven. It is to be noted that, if a plurality of injection holes are provided, some injection holes can also have the same geometrical dimensions, in particular identical inlet areas.

Further preferably, according to an example embodiment of the present invention, the injector is an inwardly opening injector, in which in order to open the injector the closing element is drawn back against a reset force, and is again placed on a sealing seat by the reset force.

The injector is preferably a fuel injector, in particular for injecting liquid fuel and/or mixtures of fuel with water and/or urea and/or alcohol and/or further additives, or is a urea injector or a water injector.

The injector is preferably designed to inject directly into a combustion chamber of an internal combustion engine.

### BRIEF DESCRIPTION OF THE DRAWINGS

In the following, a preferred exemplary embodiment of the present invention is described in detail with reference to the figures.

FIG. 1 shows a schematic sectional view of an injector for introducing a fluid according to a preferred exemplary embodiment of the present invention.

FIG. 2 shows a schematic top view of an inner region of a valve seat of the injector, the inlet areas of the injection holes being shown schematically.

FIG. 3 shows a schematic representation of the configuration of the injection holes, also showing circular segments in the shape of pie slices.

### DETAILED DESCRIPTION OF EXAMPLE EMBODIMENTS

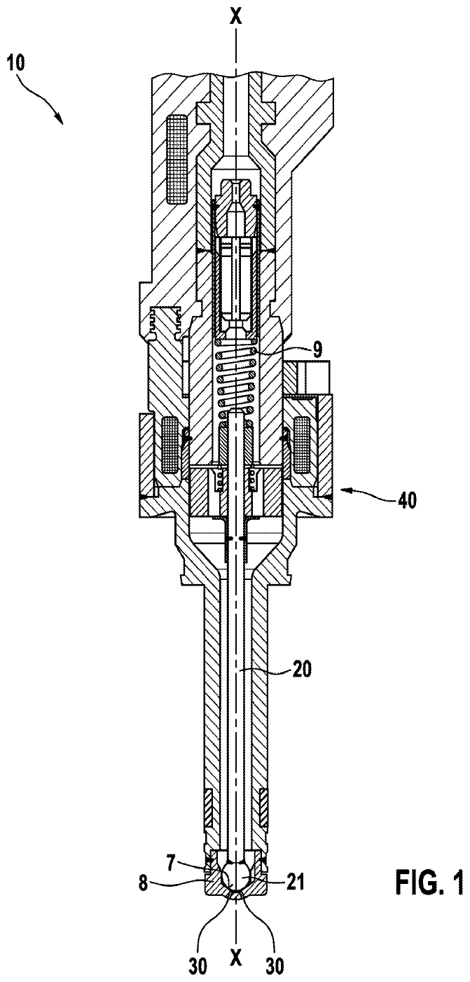

In the following, an injector 10 according to a preferred exemplary embodiment of the present invention is described in detail with reference to FIGS. 1 through 3.

Injector 10 is a fuel injector for the direct injection of fuel into a combustion chamber of an internal combustion engine. Injector 10 includes a closing element 20 in the form of a valve needle on whose free end there is situated a ball 21. The closing element is pressed into a closed position, shown in FIG. 1, by a reset element 9.

In this exemplary embodiment, injector 10 is an inwardly opening injector, closing element 20 being moved against the reset force of reset element 9 in order to open injector 10.

Injector 10 includes a multiplicity of injection holes 30, situated in a valve seat 8 of the injector.

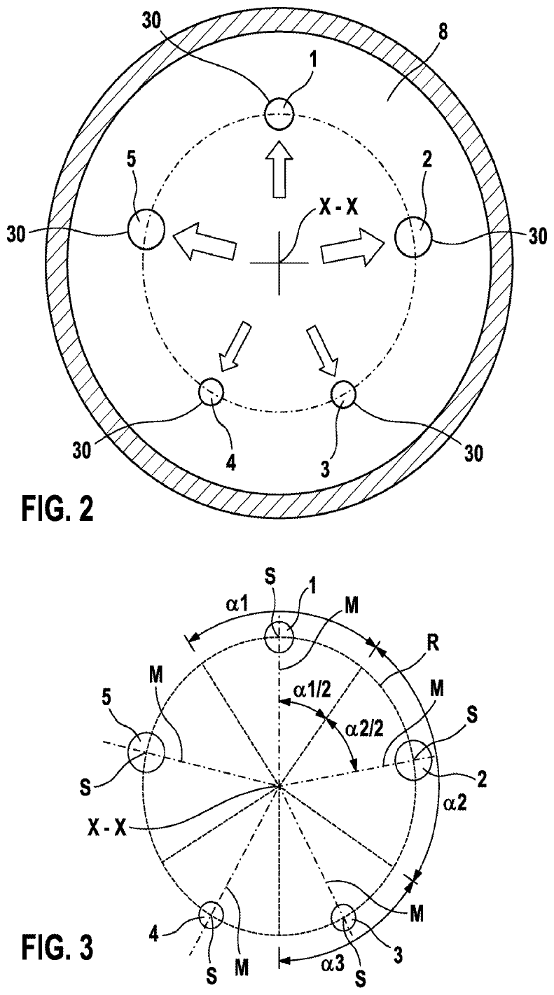

In this exemplary embodiment, as shown schematically in FIGS. 2 and 3, five injection holes 30 are provided. Injection holes 30 are numbered consecutively with the numerals 1 through 5 in FIGS. 2 and 3 in order to facilitate the assignment of the injection holes in the following description.

Closing element 20 is actuated by actuator 40, which in this exemplary embodiment is a magnetic actuator. However, it is to be noted that a piezo actuator may also be provided for the actuation of closing element 20.

Closing element 20 thus releases or closes a fluid path to a sealing seat 7 for the fuel to be injected.

As can be seen in FIGS. 2 and 3, injection holes 30 are positioned in a particular geometric configuration, and are also geometrically formed differently. In particular, the inlet areas, indicated in FIGS. 2 and 3 by the size of the circles of injection holes 30, are different. Here, the injection holes having numbers 2 and 5 are made with the largest inlet areas, and the injection holes having numbers 3 and 4 are made with the smallest inlet areas. The injection hole having number 1 is between the injection holes having numbers 2 and 5, as well as 3 and 4, with regard to the size of the inlet areas.

In addition, a spacing of the respectively adjacent injection holes 30 in the circumferential direction is selected as a function of the size of the inlet areas of injection holes 30. In this way, it is ensured that the largest quantities of fuel can flow to the injection holes having numbers 2 and 5 when the injector is open, without there being local oversupplying or competition with regard to the mass distribution of the fuel to the respective injection holes.

Here, each injection hole has assigned to it a pie piece-shaped circular segment (see FIG. 3), an injection hole center axis S lying in each case on a center line M of a circular segment.

In addition, injection hole center axes S are all situated at a common radius R about a center axis X-X of injector 10.

As can be seen in FIG. 3, a separate pie piece-shaped circular segment is assigned to each injection hole. Here, the size of an area of the circular segment corresponds to the ratio of the sizes of the inlet areas of the injection holes to one another. That is, the two largest injection holes, having numbers 2 and 5, also have the largest circular segments.

In addition, the largest and the smallest injection hole 30 have an inlet area that is a maximum of 45% of an average value of all inlet areas. The average value of the inlet areas is obtained by addition of the individual inlet areas and division by the number of injection holes.

The sizes of the circular segments are then selected corresponding to the sizes of the inlet areas of injection holes 30. It is to be noted that midpoints S of the injection holes do not necessarily have to lie on the center lines of the circular segments, but can have a deviation of ±5°.

In FIG. 3, an arc length of the circular segment at the first injection hole, having number 1, is defined by the circular angle α1. A circular segment at the second injection hole, having number 2, is defined by the circular arc α2.

Correspondingly, the center lines of the circular segments are also defined by the arcs α1/2 and α2/2.

Thus, injector 10 according to the present invention can provide an increase in a flow robustness compared to the related art. In particular, it is possible to achieve reduced scattering of injected quantities, both at different injectors and also at one injector in successive injections. In addition, a particularly homogenous flow distribution of the fuel mass flow, without mutual interference of adjacent injection holes, is achieved. In FIG. 2, the arrows again schematically show the apportioning of the overall fuel mass flow to the individual injection holes 30 when the injector is open. The size of the arrows corresponds to the size of the portion in the overall mass flow. Because the circular segments assigned to the individual injection holes correspond to the mass flow portion of the respective injection holes 30, a flow robustness when the injector is open can be significantly improved.

1-9. (canceled)

10. An injector for introducing a fluid, comprising:
a valve seat in which a multiplicity of injection holes are formed; and
a closing element that releases and closes a fluid path to the injection holes, a size of an inlet area of at least two of the injection holes being different from one another;
wherein a spacing in a circumferential direction of the injection holes to each adjacent injection hole is selected as a function of a size of inlet areas of the injection holes.

11. The injector as recited in claim 10, wherein a circular segment going out from a center axis of the injector is assigned to each injection hole of the injector holes, each injection hole center axis is situated in a range of ±5° around a center line of the circular segment, sizes of the circular segments being selected corresponding to the sizes of the inlet areas of the injection holes.

12. The injector as recited in claim 11, wherein each of the injection holes is situated on the center line of a circular segment of the circular segments.

13. The injector as recited in claim 10, wherein the injection area of each of a largest injection hole of the injection holes and a smallest injection hole of the injection holes differs by a maximum of 45% from an average value of all inlet areas of the injection holes.

14. The injector as recited in claim 10, wherein each injection hole has an injection hole center axis that has a radial distance to a center axis of the injector, each of the radial distances of the injection hole center axes differing by a maximum of 30% from an average value of all radial distances of the injection hole center axes to the center axis of the injector.

15. The injector as recited in claim 14, wherein all injection hole center axes are situated at the same radius around the center axis.

16. The injector as recited in claim 10, wherein the injector has from five to seven injection holes.

17. The injector as recited in claim 10, wherein the injector is an inwardly opening injector.

18. The injector as recited in claim 10, wherein the injector is a fuel injector or a urea injector or a water injector.
